(19) United States
(12) Patent Application Publication
(10) Pub. No.: US 2011/0128831 A1
(43) Pub. Date: Jun. 2, 2011

(54) METHOD OF USING BACKUP IMAGE OF OPTICAL DISC

(76) Inventor: Woogil KIM, Seoul (KR)

(21) Appl. No.: 12/956,728

(22) Filed: Nov. 30, 2010

(30) Foreign Application Priority Data
Dec. 2, 2009 (KR) 10-2009-0118381

(51) Int. Cl. G11B 7/085

(52) U.S. Cl. 369/30.19; G9B/7.042

(57) ABSTRACT

This document relates to a method of using a backup image of an optical disc. In an embodiment of this document, data of an optical disc inserted into an Optical Disc Drive (ODD), included in a disc drive integrated with a Solid State Drive (SSD), may be backed up in the SSD in the form of an image file, and access to the optical disc may be bypassed to the backup image file. Backing up the data and bypassing the access may be executed by an application program in the operating system of a host coupled to the disc drive. The application program may be automatically executed when the optical disc is inserted into the ODD or by manipulation of a predetermined button provided in the disc drive. Furthermore, the application program may set the backup image file of the SSD to a virtual drive for the optical disc.

This application claims the benefit of Korean Patent Application No. 10-2009-0118381 filed on Dec. 2, 2009, which is hereby incorporated by reference.

### BACKGROUND

1. Field

This document relates to a method of backing up data, recorded into an optical disc inserted into an Optical Disc Drive (ODD), in a Solid State Drive (SSD) integrally coupled with the ODD in the form of an image file and using the data.

2. Related Art

Various types of ODDs for recording data into optical discs, such as CD, DVD, and BD, and playing the recorded data are being widely used.

The ODD, as shown in FIG. 1, comprises an optical pickup 11, a play/recording unit configured to drive a spindle motor, a sled motor, and the optical pickup 11 and process a servo signal and play/recording data, an interface unit 16 coupled to a host, memory 17, a controller 18 configured to control the play/recording unit, and so on. The play/recording unit may comprise an optical driving unit 12, an RF unit 13, a digital signal processor (DSP) 14, a servo/driving unit 15, etc. The optical driving unit 12 may be included in the optical pickup 11.

The controller 18 controls the servo/driving unit 15 such that the servo/driving unit 15 rotates the spindle motor and the sled motor, thus rotating an optical disc at a predetermined speed, and also moves the optical pickup 11 to the inner circumferential area of the optical disc. Furthermore, the controller 18 controls the play/recording unit such that the play/recording unit performs a data recording or play operation of recording data into the optical disc and playing data stored in the optical disc.

Meanwhile, an SSD (that is, information storage device using semiconductor memory) is being spread. For example, the SSD may be coupled to a host in accordance with an AT Attachment (ATA) interface method and used together with a Hard Disc Drive (HDD) in a Personal Computer (PC), or the SSD replaces the HDD.

The SSD, as shown in FIG. 2, comprises a flash memory array 20, a memory interface unit 21, a controller 22, an interface (I/F) unit 23, and so on.

unlike the ODD or HDD, the SSD does not include elements mechanically driven. Accordingly, the SSD can be made slim, and it is very advantageous from a viewpoint of the data access speed, the occurrence of noise, and power consumption.

Products in which the ODD and the SSD are integrated have recently been developed. There is a need for a method of playing an optical disc by taking advantages of the SSD having a fast access speed, low power consumption, and low noise.

### SUMMARY

An aspect of this document is to provide a method of using data of an optical disc inserted into an ODD through an SSD after first accessing the data in a device in which the ODD and the SSD are integrated.

In an aspect of this document, a method of using a backup image of an optical disc comprises backing up data of an optical disc inserted into an Optical Disc Drive (ODD), included in a disc drive integrated with a Solid State Drive (SSD), in the SSD in the form of an image file and bypassing access to the optical disc to the backup image file.

In an embodiment, backing up the data and bypassing the access may be executed by an application program in the operating system of a host coupled to the disc drive.

In an embodiment, the application program may be automatically executed when the optical disc is inserted into the ODD or the disc drive is reset or by manipulation of a predetermined button provided in the disc drive.

In an embodiment, the application program may be automatically executed when disc information about the optical disc inserted into the ODD is sent to the operating system.

In an embodiment, the application program may set the backup image file of the SSD to a virtual drive for the optical disc.

In another aspect of this document, a disc drive in which an ODD and an SSD are integrated comprises the ODD; the SSD; and a Port Multiplier (PM) for connecting the ODD and the SSD to a host. When disc information about an optical disc inserted into the ODD is sent to the host through the PM, an application program automatically executed in an operating system of the host backs up data of the optical disc in the SSD in the form of an image file and bypasses access to the optical disc to the backup image file.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is a block diagram showing the construction of a common ODD;

FIG. 2 is a block diagram showing the construction of a common SSD;

FIG. 3 is a block diagram showing the construction of a disc drive in which an ODD and an SSD are integrally combined according to this document and an embodiment of the disc drive coupled to a host; and

FIG. 4 is a flowchart illustrating a method of using a backup image of an optical disc according to an embodiment of this document.

### DETAILED DESCRIPTION

Hereinafter, a method of using a backup image of an optical disc according to an embodiment of this document is described in detail with reference to the attached drawings.

In this document, in order to reduce access to an optical disc inserted into an ODD to a minimum in a disc drive in which the ODD and an SSD are integrally combined, data of the optical disc is stored in the SSD in the form of an image file, and a host does not access the ODD, but uses the image file stored in the SSD.

When a disc, such as a game disc, a video disc, or an installation disc, is inserted into the ODD, according to user's selection or automatically a predetermined application program is executed in an Operating System (OS). The application program generates an image file of the disc and records the image file in the SSD. A virtual drive is generated for the corresponding image. When another application program attempts to access the ODD, it accesses the image file of the SSD not the ODD.

The application program may comprise a program module for reading a disc inserted into the ODD, generating an image file of the disc, and recording the image file into the SSD and a program module for generating a virtual drive such that access to the ODD is bypassed.

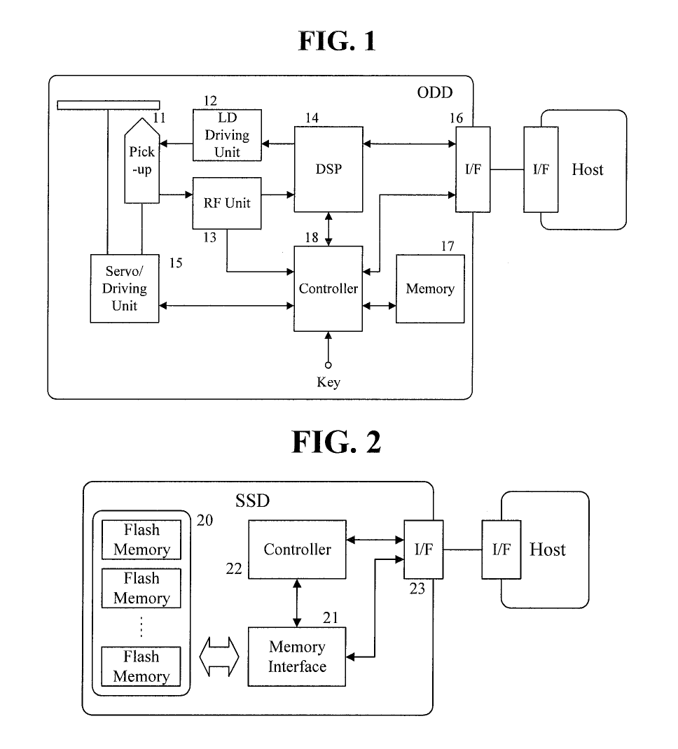

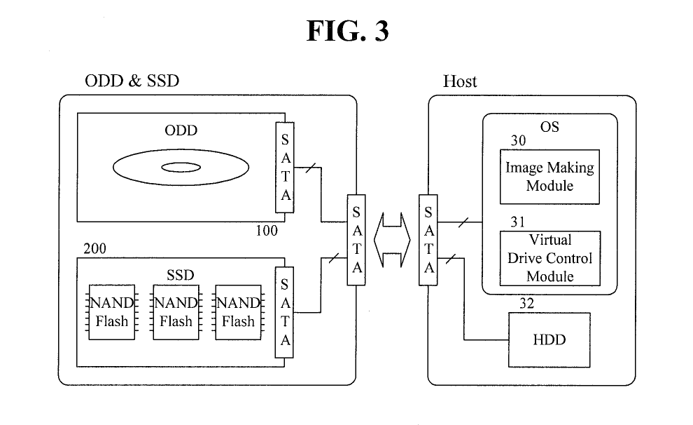

FIG. 3 is a block diagram showing the construction of a disc drive in which an ODD and an SSD are integrally combined according to this document. The ODD 100 constructed as described above with reference to FIG. 1 and the SSD 200 constructed as described above with reference to FIG. 2 are fabricated in the form of one integrated device.

The ODD 100 and the SSD 200 are coupled to a host, such as a PC, through, for example, a Serial ATA (SATA) interface. The ODD and the SSD can communicate with the host through the SATA interface. In the disc drive of FIG. 3 in which the ODD and the SSD are integrally combined, the ODD and the SSD comprise respective SATA interfaces. The SATA interfaces of the ODD and the SSD can be coupled to the host through a Port Multiplier (PM) as one SATA interface.

When an optical disc is inserted into the ODD according to user's selection or automatically, the OS of the host executes the applications of an image making module 30 and a virtual drive control module 31. The application reads data of the optical disc inserted into the ODD, generates an image file (e.g., *.iso) using the read data, backs up the generated image file in the SSD, and loads the image file of the SSD onto one virtual drive. Accordingly, another application program does not access the ODD, but plays and uses the backup image file. This is described in detail below.

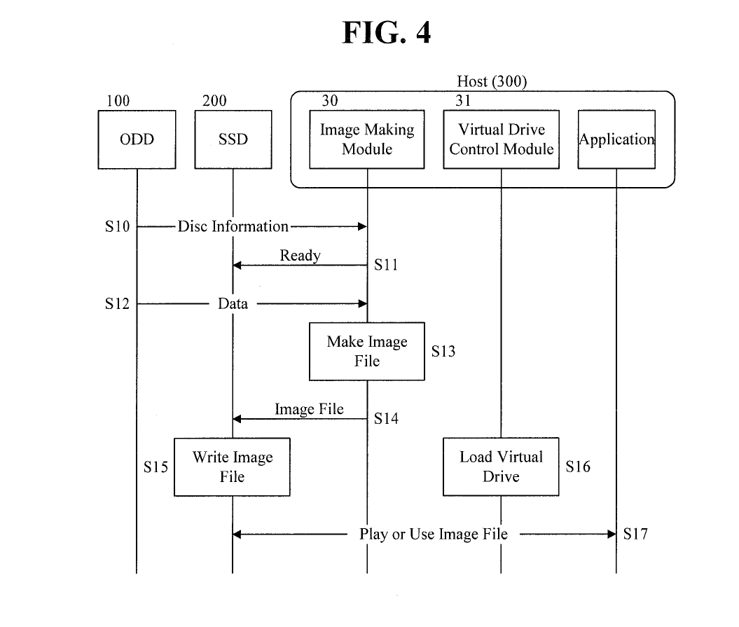

FIG. 4 is a flowchart illustrating a method of using a backup image of an optical disc according to an embodiment of this document.

When an optical disc is inserted into the ODD 100, as described above with reference to FIG. 1, the controller 18 controls the play/recording unit such that the play/recording unit reads disc information recorded into the lead-in area of the optical disc by performing the spindle servo and sled servo operations for rotating the spindle motor and the sled motor and performing focus and tracking servo operation and sends the read disc information to the host 300 coupled to the ODD 100 through the SATA interface at step S10.

The OS of the host 300 executes the image making module 30 automatically or according to user' selection and requests a ready operation for recording an image file from the SSD 200 at step S11.

Furthermore, the image making module 30 controls the ODD 100 such that the ODD 100 reads data recorded into the optical disc and sends the read data to the host 300 at step S12. The image making module 30 generates an image file (e.g., *.iso) for the read data at step S13.

The image making module 30 sends the generated image file to the SSD 200 at step S14. The controller 21 of the SSD 200 write the image file into the flash memory array 20 at step S15. The steps S12 to S15 may be sequentially performed after the entire process is finished, but may be repeatedly performed until the data recorded into the optical disc is stored in the flash memory array of the SSD in the form of an image file.

Furthermore, in the OS of the host 300 the virtual drive control module 31 is executed to load the image file of the SSD onto a virtual drive for the optical disc at step S16. Accordingly, another application program, such as a video play program, can access the image file of the SSD loaded onto the virtual drive and read or play the image file or copy the image file to another storage medium, such as a HDD at step S17.

The image making module 30 and the virtual drive control module 31 may be implemented in the form of a single application program. When the optical disc is inserted into the ODD and disc information of the optical disc is sent to the host, the image making module 30 and the virtual drive control module 31 may be automatically driven by the OS such that the steps S11 to S16 can be executed. When the ODD is loaded as a virtual drive, another application program attempting to access the ODD accesses the image file stored in the SSD.

In some embodiments, the image making module 30 and the virtual drive control module 31 implemented as one program may be executed when a user selects them in the OS (that is, when a corresponding program is selected) or may be executed by manipulating a predetermined button or an eject button of a specific pattern provided in the ODD.

In some embodiments, the image making module 30 and the virtual drive control module 31 may not be executed in the OS of the host, but may be implemented in the form of firmware of a disc drive in which the ODD and the SSD are integrated. In this case, when an optical disc is inserted (or the corresponding disc drive is reset), data of the optical disc may be read automatically or according to user's selection through the manipulation of a button provided in the disc drive, and the read data may be directly stored in the SSD in the form of an image file without passing through the host. When access to the ODD is attempted, the host can bypass the access to the image file stored in the SSD.

Accordingly, since the backup image file stored in the SSD is used in the host, access to the ODD can be reduced to a minimum, noise or power consumption can be reduced, and the performance of data processing and user convenience can be improved.

As described above, the SSD having advantages from a viewpoint of the data access speed, the occurrence of noise, and power consumption in order to use data stored in an optical disc can be used instead of the ODD. Accordingly, the performance of data processing and user convenience can be improved.

The foregoing embodiments and advantages are merely exemplary and are not to be construed as limiting this document. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A method of using a backup image of an optical disc, comprising:
backing up data of an optical disc inserted into an Optical Disc Drive (ODD), included in a disc drive integrated with a Solid State Drive (SSD), in the SSD in the form of an image file; and
bypassing access to the optical disc to the backup image file.

2. The method of claim 1, wherein backing up the data and bypassing the access are executed by an application program in an operating system of a host coupled to the disc drive.

3. The method of claim 2, wherein the application program is automatically executed when the optical disc is inserted into the ODD or the disc drive is reset.

4. The method of claim 3, wherein the application program is automatically executed when disc information about the optical disc inserted into the ODD is sent to the operating system.

5. The method of claim 2, wherein the application program is executed by manipulation of a predetermined button provided in the disc drive.

6. The method of claim 2, wherein the application program sets the backup image file of the SSD to a virtual drive for the optical disc.

7. The method of claim 5, wherein an application program executed in the operating system uses the image file of the SSD coupled to the application program through the virtual drive.

8. A disc drive in which an ODD and an SSD are integrated, comprising:
the ODD;
the SSD; and
a Port Multiplier (PM) for connecting the ODD and the SSD to a host,
wherein when disc information about an optical disc inserted into the ODD is sent to the host through the PM, an application program automatically executed in an operating system of the host backs up data of the optical disc in the SSD in the form of an image file and bypasses access to the optical disc to the backup image file.

9. The disc drive of claim 8, wherein the application program sets the backup image file of the SSD to a virtual drive for the optical disc.

10. The disc drive of claim 8, wherein an application program executed in the operating system uses the image file of the SSD through a virtual drive.
